(19) United States
(12) Patent Application Publication
(10) Pub. No.: US 2007/0126925 A1
(43) Pub. Date: Jun. 7, 2007

(54) Imaging apparatus

(75) Inventors: Keisuke Masuda, Yokohama (JP); Keiichi Tadokoro, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/603,492

(22) Filed: Nov. 21, 2006

(30) Foreign Application Priority Data
Nov. 21, 2005 (JP) 2005-335123

(51) Int. Cl. H04N 5/225

(52) U.S. Cl. 348/375

(57) ABSTRACT

Within a video camera, comprising: a camera portion for taking in video information to be photographed; a recording portion for recording the video information taken in from said camera portion; and a high-speed photographing button provided for setting up the video camera into a high-speed photographing mode for staring the photographing at high speed, wherein the high-speed photographing button is positioned on a rear and upper surface portion of the video camera, thereby disposing the high-speed photographing button at such the position that a photographer can acknowledge it easily when she/he holds the video camera in hand. Also, a predetermined step is provided so that an upper surface of the member, on which the operation switch is positioned, comes to be higher than a surface of the rear and upper surface portion, on which the high-speed photographing button is positioned, thereby disposing the high-speed photographing button at such the position that the photographer cannot push down the high-speed photographing button, erroneously, confusing it with other button(s) when photographing.

### BACKGROUND OF THE INVENTION

The present invention relates to an imaging apparatus, using therein a recording medium, such as, an optical disk or a magnetic tape, etc., and in particular, it relates to an arrangement a button for use of high-speed shooting or photographing.

For a video camera, as one example of the imaging apparatus, using therein the recording medium, such as, the optical disk or the magnetic tape, etc., it is important to save electric power therein, for achieving a long time use thereof, as well as, small-sizing thereof, and in general, under the condition of turning the electric power OFF, supplying of electric power to a function portion(s), not being used, is stopped to the utmost, and thereby obtaining saving of the electric energy as much as possible.

On the other hand, for such video camera, quick starting is also required, in particular, when starting the recording operation thereof, so as not to loose the chances for recording. For achieving the quick starting when photographing and recording, while obtaining saving of the electric energy therein, a new model appears on the market, being provided with a high-speed photographing start mode for supplying the electric power to a photographing system and a drive system for driving the recording medium, and further that being provided a button for exclusive use of that high-speed photographing start mode.

On a digital video camera “NV-GS250”, made by Matsushita Electric Industrial co., Ltd. (Japan), a “quick start button” is disposed on a side surface of the rear portion thereof. When a quick start lamp is lighten by pushing down this quick start button, the camera is in the condition of stopping the photographing function, and thereby enabling to obtain the operation up the start of recording at high-speed (see pages 9 and 35 of a user's manual: Non-Patent Document 1).

By the way, due to small-sizing of the video camera, buttons provided reach or come close to each other on the surface of the video camera, and there are cases of making operation, mischievously, without watching or looking at the buttons, such as, when photographing, for example; therefore a demand is made on disposition of the buttons so that such mischievous operation can be made, hardly.

With the conventional art for preventing the camera from being made with such the mischievous operation, for achieving an object “to prevent the switch for photographing from the mischievous operation and to reduce electric energy consumption therein”, there is disclosed “the video camera, on which a switch for photographing is provided in vicinity of a hand supporting or holding it, wherein a cover 6 is provided near to a switch 13, being concealed or exposed, so that the switch 13 is inoperable in the condition thereof, and a power source for a driver means for electromotive zoom and/or an automatic white-balance, etc., can be turned ON or OFF, in synchronism with movement of that cover” (for example, see Japanese Patent Laying-Open No. Hei 5-110917 (1993): Patent Document 1).

Further, with the conventional art for prohibiting it from covering or touching on other sensor(s) and/or button(s) when a user holds a grip of the camera, for achieving an object “to provide a camera for enabling correct measurement of colors without being covered with the hand, irrespective of a way of posturing the camera, such as, in the horizontal position or the vertical position”, there is disclosed “a video camera, on a side surface of a main body of which is formed a side grip 1, and on that side grip are provided a holding portion 2, which is gripped when holding the camera by hand, and a color measurement device 3 of an external light, which is positioned at such position that the hand does not touch thereon when holding a lower portion of the holding portion on a front surface of the side grip” (for example, see Japanese Patent Laying-Open No. Hei 10-010626 (98): Patent Document 2).

### BRIEF SUMMARY OF THE INVENTION

As was mentioned above, a new model appears on the market, which is provided with the button for exclusive use of the high-speed photographing start mode (herein, being called by a “high-speed photographing button”), for achieving the quick starting when photographing and recording while obtaining saving of the electric energy. This high-speed photographing button is required to locate at a position, such that the user can easily acknowledge it when she/he holds the video camera. Further, it is also required to locate at a position, such that the button cannot be pushed down, erroneously, confusing it with other button, by the user when photographing.

Normally, with a normal video camera, when trying to photographing and recording therewith, the video camera is held on grip thereof by hand passing through a belt, in general. The photographer operates the high-speed photographing button while keeping that holding condition, i.e., watching or looking at the video camera from above on a rear side thereof. For that reason, the high-speed photographing button can be operated easily, with preferable visibility, when disposing it on an upper surface of the rear side of the video camera.

However, in relation with the conventional art described in the Non-Patent Document 1 mentioned above, because the quick start button, i.e., the high-speed photographing button, is located on a side of the rear surface, the button comes to be watched or looked at obliquely from above; therefore, there is a problem that the visibility thereof goes down inferior. Further, because the quick start button is disposed on same the rear surface, neighboring with others, such as, a menu button, a start/pause button of photographing, etc.; therefore, there are cases where it is operated erroneously. Thus, since the photographer cannot see the button when she/he looks through a finder when photographing, then there is a problem that she/he cannot distinguish the quick start button from the menu button and/or the start/pause button of photographing, thereby pushing down it in error.

Also, in relation with the conventional art described in the Patent Document 1 mentioned above, since there is necessity of providing the cover for covering the button (i.e., the photographing button), so as to protect it from mischievous operation, it has a problem that it brings about cost-up of the video camera.

Moreover, with the conventional art described in the Patent Document 2 mentioned above, a sensor is provided at the position where the hand does not touch thereon when the camera main body is held by hand, and further is provided a projection portion between the grip and the sensor. However, it is necessary to provide the high-speed photographing button upon the upper surface on the rear side of the video camera, but this portion is small in the space or narrow, and therefore brings about a problem that it is difficult to dispose the high-speed photographing button with keeping a distance from the grip so that no touching occurs therebetween. Furthermore, since the grip is located at the highest position of the video camera, providing of the projection portion brings about a problem that the video camera comes to be tall in the height thereof.

An object, according to the present invention, is to provide an imaging apparatus, with which the visibility of a high-speed photographing button can be improved, in particular, with the imaging apparatus comprising the high-speed photographing button therein. Also, other object, according to the present invention, is to provide an imaging apparatus, enabling to prevent it from the mischievous operation thereof.

For accomplishing the object(s) mentioned above, according to the present invention, there is provided an imaging apparatus, comprising: a camera portion, which is configured to take in video information to be photographed; a recording portion, which is configured to record the video information taken in from said camera portion; and a high-speed photographing button provided, which is configured to set up said imaging apparatus into a high-speed photographing mode for staring the photographing at high speed, wherein said high-speed photographing button is positioned on a rear and upper surface portion of said imaging apparatus.

According to the present invention, it is possible to provide an imaging apparatus, in particular, being improved on the usability thereof.

### BRIEF DESCRIPTION OF THE DRAWING

Those and other objects, features and advantages of the present invention will become more apparent from the following description when taken in conjunction with the accompanying drawings wherein:

FIG. 1 is a perspective view of a video camera, according to an embodiment of the present invention, being viewed obliquely from a front thereof;

FIG. 2 is a perspective view of a video camera, according to an embodiment of the present invention, being viewed obliquely from a rear thereof;

FIG. 3 is a view for showing a relationship between the video camera, according to the present invention, and a right hand of a photographer; and

FIG. 4 is a cross-section view of the video camera, according to the present invention.

### DETAILED DESCRIPTION OF THE INVENTION

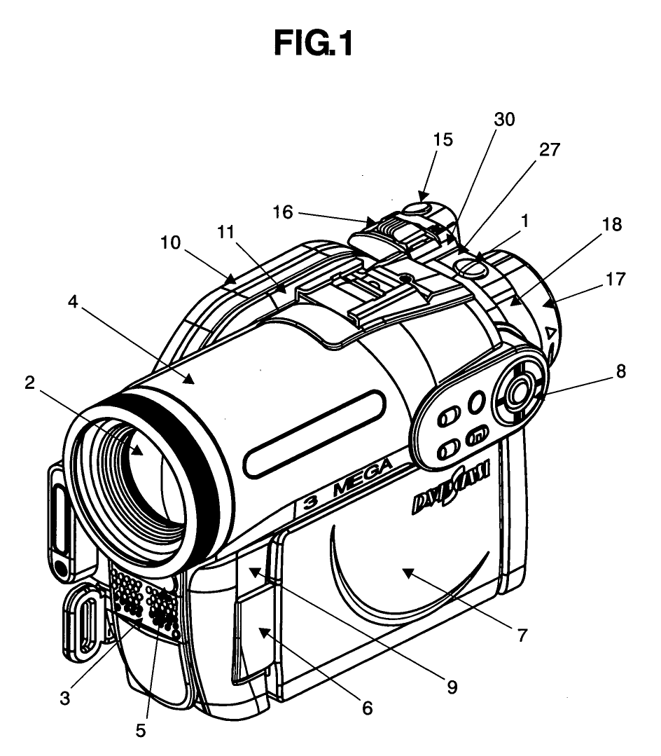

Hereinafter, explanation will be made on an embodiment, i.e., a video camera, as an example, according to the present invention, by referring to the attached drawings, FIGS. 1 to 4.

### EMBODIMENT 1

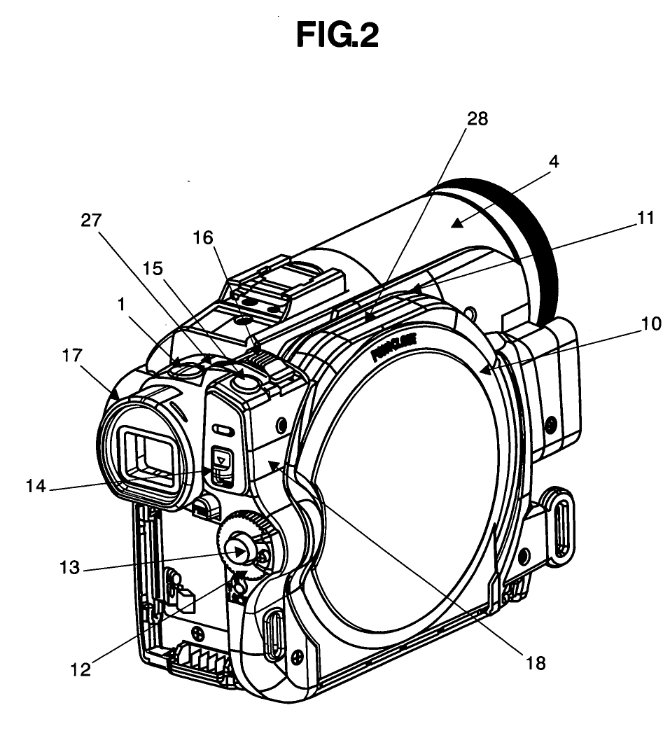

The structures of the video camera according to the present embodiment will be explained, by referring to FIGS. 1 and 2. This FIG. 1 is a perspective view of the video camera, according to the present invention, being viewed obliquely from a front, and FIG. 2 a perspective view thereof, but being viewed obliquely from a rear.

The video camera, according to the present embodiment, is construed with a front side, comprising therein a lens portion 2 for guiding an image of an object to be photographed (not shown in the figure), a microphone portion 3, a lens cover 4, and a front case 5, etc., a liquid crystal display side, comprising therein a LCD supporting portion 6, a LCD (i.e., Liquid Crystal Display) panel portion 7, a jog button 8, a “L”-shaped case 9, etc., a grip side, comprising therein a disk cover 10 for protecting a drive unit (not shown in the figure), as being a recording portion for recording on an optical disk (not shown in the figure) and “R”-shaped case 11, etc., and a rear side, comprising therein an EVF (Electric View Finder) portion 17, a rear case 18 and a battery (not shown in the figure), separately.

Image information is obtained through conversion an image of an object photographed through the lens portion 2 into a video signal via an image pickup element and a processing circuit (not shown in the figure) building up the camera portion, and the video information is recorded on the optical disk, at any time, by means of a drive unit (not shown in the figure), while being displayed on the EVF portion 17 and the LCD portion 7. Audio information is collected through the microphone portion 3, and is recorded on the optical disk, at any time, by means of the drive unit (not shown in the figure).

The LCD portion 7 can be rotated around the LCD supporting portion 6, to be opened/closed, and thereby being adjustable at an angle suitable for the condition of use. On a surface neighboring to the LCD portion 7, when it is closed, is disposed the jog button 8, etc., to be used mainly when reproducing. A mode change knob 12, which is provided on the rear side, switches ON/OFF of an electric power and exchanges between a motion picture mode and a still picture mode. A recording button 13 is a button for conducting a start or a stop of recording. A disk take-out knob 14 is used when loading or unloading the optical disk, and the disk cover 10 is opened when this disk take-out knob 14 is pushed down, so as to enable loading or unloading of the optical disk. A photo button 15 is used when photographing a still picture, and the still picture of the image of object, which is taken into from the lens portion 2, is recorded on the optical disk, to be the video information through the drive unit (not shown in the figure), when this photo button 15 is pushed down. A T/W lever 16 us used for zooming up the image of object, which is taken into from the lens portion 2. A grip portion 28 is formed to be a part of the R case 11, to be gripped by fingers when the present video camera is held by hand, i.e., a photographer holding the present video camera, gripping this grip portion 28 by using a middle finger or the like, of the right hand, at the same time, is able to operate the photo button 15 and/or the T/W lever 16 by using an index finger or the like, of the right hand.

Next, explanation will be given on the high-speed photographing button, according to the present embodiment.

First of all, explanation will be made about the function by means of the high-speed photographing button 1, briefly. When pushing down the high-speed photographing button 1, the electric power is supplied to the circuit(s) and the unit(s) relating to photographing, such as, focusing of the image of object, and also the circuit(s) and the unit(s) relating to recording onto the optical disk, etc., and therefore the video camera comes into a waiting condition of recording (i.e., a high-speed photographing mode), for photographing and recording (hereinafter, being called by only “recording”). And further, within the structures thereof, a light-emitting diode (not shown in the figure), which is provided within an inside of the high-speed photographing button 1, is lighten up when the video camera is in the high-speed photographing mode, thereby noticing that to the photographer. This high-speed photographing mode differs from the condition of turning OFF the electric power by means of the mode change button 13, in that the electric power is supplied only to the circuit(s) and the unit(s) relating to the photographing and recording, and also differs from the condition of turning ON the electric power, in that the electric power is not supplied to the circuit(s) for image processing, etc., thereby achieving a function of shortening the timing for starting the photographing and recording while obtaining energy saving.

Herein, consideration will be made on the timing when the photographer uses or pushes down the high-speed photographing button 1 mentioned above. The timing when the photographer uses or pushes down the high-speed photographing button 1 can be considered the case of waiting for the time, until when she/he takes a picture next time after once conducting the recording, after turning ON the electric power of the present video camera by means of the mode change button 13. Thus, the photographer has the waiting time up to the next recording timing, but since that waiting time can be considered relatively short, therefore it can be guessed that the photographer is in the condition of holding the video camera in her/his hand while brining her/his hand, from the position of setting the video camera at her/his eye, down to around her/his waist, naturally. In this instance, when seeing the video camera from the photographer, due to the weight thereof, the video camera comes down a little bit lower than her/his hand, i.e., in the position of watching the video camera from above on the rear side thereof, as is shown in FIG. 2. Then, it is necessary for the photographer to confirm the high- speed photographing button 1 within this region of a filed of view. Also, in case when the photographer predicts that the waiting time is relatively long until the next recording timing, it can be guessed that the photographer puts the video camera directing the bottom surface thereof within the region of her/his own visual field, and within the region where she/he can hold the video camera therein by stretching her/his hand. In this instance, in particular when seeing the video camera from the photographer, there are cases that any one of the surfaces of the front side, the LCD side, the grip side and the rear side of the video camera, comes to the position where the photographer cannot see it, depending on the direction in which the video camera is put on. However, it is necessary that the high-speed photographing button 1 can be confirmed within the region of visual field when the photographer sees the upper surface of the video camera, to be the surface falling in the region of visual field of the photographer, even in the case of putting the video camera in any direction. Under those two (2) conditions, the position where the photographer can confirm the high-speed photographing button 1, easily, is a rear and upper surface 27 of the video camera. Then, according to the present embodiment, the high-speed photographing button 1 is disposed on the rear and upper surface 27 of the video camera, as is shown in FIGS. 1 and 2.

Also, since the high-speed photographing button 1 is disposed close to the T/W lever 16 and the photo button 15, a predetermined step 30 is provided between the upper surface of the rear and upper surface 27 formed to be a part of the rear case 18, on which the high-speed photographing button 1 is positioned, and the upper surface of the R-shaped case 11, on which the T/W lever 16 and the photo button 15 are positioned. Since the rear and upper surface 27, on which the high-speed photographing button 1 is positioned, is located to be lower than the upper surface of the R-shaped case 11, due to this step 30, the photographer can distinguish the side on which the high-speed photographing button 1 is positioned, from the side on which the T/W lever 16 and the photo button 15 are positioned, then it is possible to prohibit the photographer from pushing down the high-speed photographing button 1, erroneously, when she/he tries to operate the photo button 15 and/or the T/W lever 16.

Further, when the video camera is turned into the high-speed photographing mode, lighting is made on the light emitting diode (the details thereof will be mentioned later), which is provided within the high-speed photographing button 1, so as to notice it to the photographer, therefore the visibility thereof can be improved much more.

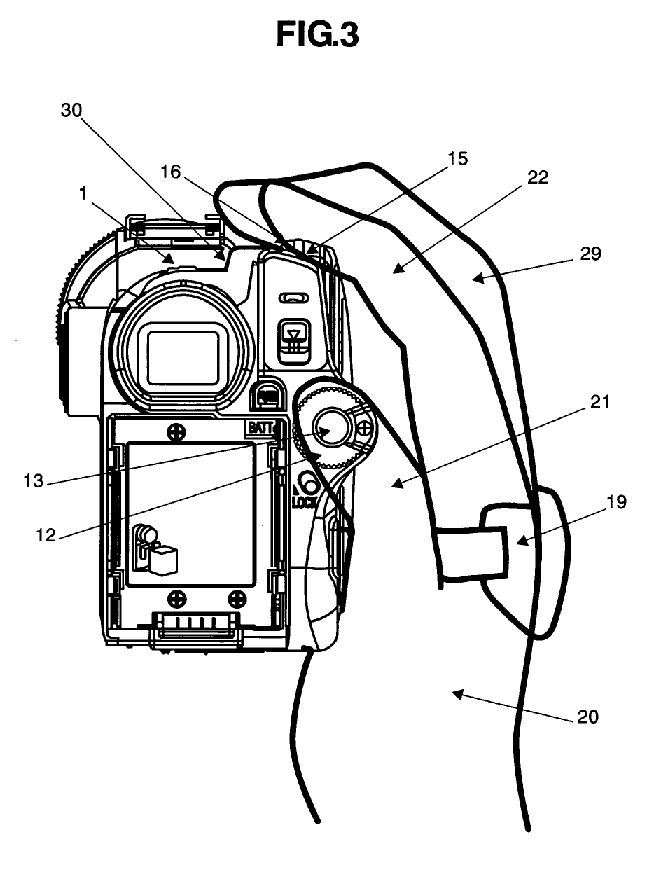

Next, explanation will be given about the positional relationship between the fingers and the respective buttons, when the video camera is held on the hand, by referring to FIG. 3. This FIG. 3 shows the positional relationship, in particular, between the video camera and the right hand of the photographer.

FIG. 3 shows a view when the photographer holds the video camera, passing her/his right hand 20 through a hand strap 19, i.e., gripping the grip 20 shown in FIG. 2 by the middle finger 29 of the right hand or the like, while putting the thump 21 thereof on the mode change knob 12 or the recording button 13, and the index finger 22 thereof on the photo button 15 or the T/W lever 16; and under that condition, she/he fastens the hand strap 19, and fix the right hand, so as to take a picture.

Herein, the rear and upper surface 27, on which the high-speed photographing button 1 is positioned, is disposed at the position lower than the upper surface of the R-shaped case 11, because of the predetermined step 30. Thus, because of the function of this step 30, it is possible for the photographer to distinguish the side on which the high-speed photographing button 1 is positioned, from the side on which the T/W lever 16 and the photo button 15 are positioned, even in a case where the finger of the photographer climbs over the T/W lever 16 or the photo button 15, erroneously, when she/he tries to operate the T/W lever 16 or the photo button 15, or in a case where the finger of the photographer climbs over the T/W lever 16 or the photo button 15, when a person having a big hand holds the video camera, thereby enabling to prohibit the photographer from pushing down the high- speed photographing button 1, erroneously.

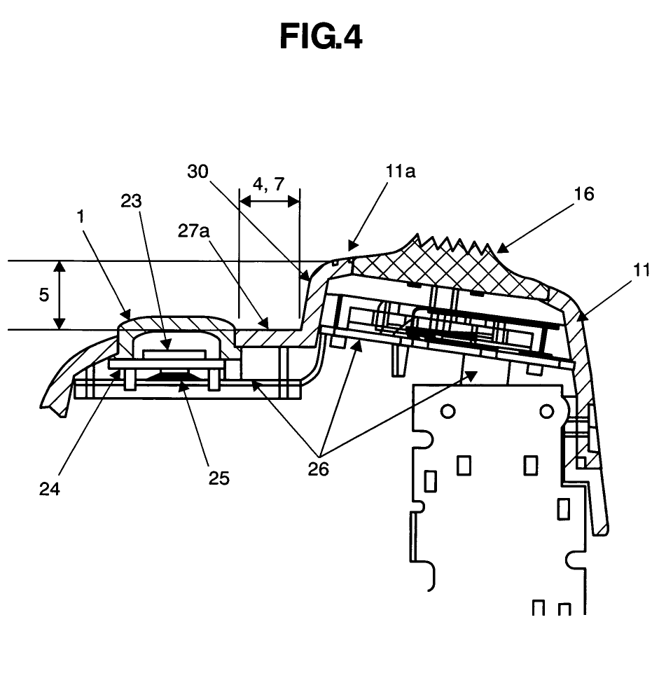

Next, detailed explanation will be made on the predetermined step and the internal structure thereof, by referring to FIG. 4. This FIG. 4 shows the cross-section view of the video camera, according to the present embodiment. Since the high-speed photographing button 1 and the T/W lever 16 come close to each other, at the most, then explanation will be made by referring to the cross-section of this portion.

First of all, explanation will be given about the predetermined step 30 provided for the purpose of preventing from the mischievous operation. Thus, positioning a surface 27a of the rear and upper surface, on which the high-speed photographing button 1 is positioned, at the position between a R-shaped upper surface 11a of the R-shaped case 11, which builds up a portion on the right-hand side of the present video camera, being lowered by a size of that predetermined step (for example, 5 mm), it is possible to notice that the index finger 22 of her/his right hand climbs over, because of the step 30, even when it climbs over the T/W lever 16, and thereby prohibiting the photographer from erroneously pushing down the high-speed photographing button 1 lying at the lower position.

Further, it is possible to obtain such the structure that touching cannot be made directly upon the high-speed photographing button 1, by taking the distance from the position at the lower side of the step 30 to the high-speed photographing button 1 to be a predetermined value (for example, 4.7 mm), and thereby further enabling to prevent the mischievous operation thereof.

In case where the T/W lever 16 operated by the index finger 22 of the right hand and the high-speed photographing button 1 are provided on the same surface, there is difficulty of distinguishing the partition provided between them, comparing to the case where the step 30 is provided; therefore, it is necessary to dispose those buttons, separating further far from each other. For that reason, there is necessity of enlarging the configuration of the rear case 19, which makes up the rear and upper surface portion, or of disposing the high-speed photographing button 1 on the LCD side, which cannot be seen from, depending upon an angle of the view. On the other hand, according to the present embodiment, with provision of the predetermined step 30 between the rear and upper surface 27, on which the high-speed photographing button 1 is provided, and the upper surface of the R-shaped case 11, the high-speed photographing button 1 can be acknowledged easily, within a limited space, without enlarging the outer configuration of the video camera, and therefore it can be prevented from being operated, erroneously.

Next, explanation will be given about the internal structures of the high-speed photographing button 1. The high-speed photographing button 1 is made from molding of a material having a light permeability (but, the surface is treated with a light permeable spattering process), and within an inside of the high-speed photographing button 1 is disposed an LED (i.e., the light emitting diode) 23. Under the high-speed photographing button 1 and the LED 23 is provided a tact switch 25, putting an actuator 24 between them, as an operation part, and further provided with a flexible portion 26 for connecting the LED 23 and the tact switch 25 electrically. Moreover, with the flexible portion 26 are also connected a tact switch for the photo button 15 and a switch for the T/W lever 16, thereby electric signals are collected thereon, to be transferred to a MAIN substrate, which is mounted on a main circuit of the present video camera. When pushing down the high-speed photographing button 1, the actuator 24 moves into a lower direction along wit a guide (not shown in the figure) in the structures, so as to push down the tact switch 25, therefore the high-speed photographing mode is exchanged, and when it is changed into the high-speed photographing mode, the LED 23 is lighten up. With such the structures, i. e., connecting the flexible portion mounting the tact switch for the photo button 15 and the switch for the T/W lever 16 thereon, collectively, while setting the position of the high-speed photographing button 1 at the rear side, there is no necessity of extending the flexible portion, but directly to the MAIN substrate; therefore, it is possible to suppress the cost up of the video camera.

Also, according to the present embodiment, with disposing the high-speed photographing button 1 within a vacant space defined between a finder member within the EVF portion 17 and the rear case 18 of an outer casing, it is possible to escape the video camera from becoming large-sized.

As was mentioned above, according the embodiment, within the video camera equipped with the high-speed photographing button therein, it is possible to improve the visibility of the high-speed photographing button, and also to prevent it from the mischievous operation, thereby enabling to provide the video camera increasing the usability thereof.

While we have shown and described several embodiments in accordance with our invention, it should be understood that discloses embodiments are susceptible of changes and modification without departing from the scope of the invention. Therefor, we do not intend to be bound by the details shown and described herein but intend to cover all such changes and modifications that falls within the ambit of the appended claims.

What is claimed is:

1. An imaging apparatus, comprising:
a camera portion, which is configured to take in video information to be photographed;
a recording portion, which is configured to record the video information taken in from said camera portion; and
a high-speed photographing button provided, which is configured to set up said imaging apparatus into a high-speed photographing mode for staring the photographing at high speed, wherein said high-speed photographing button is positioned on a rear and upper surface portion of said imaging apparatus.

2. The imaging apparatus, as described in the claim 1, wherein said high-speed photographing button, which is positioned on the rear and upper surface portion of said imaging apparatus, and an operation switch, which is positioned on a member building up a right-hand side portion of said imaging apparatus, are located closely to each other, and a predetermined step is provided so that an upper surface of said member, on which said operation switch is positioned, comes to be higher than a surface of said rear and upper surface portion, on which said high-speed photographing button is positioned.

3. The imaging apparatus, as described in the claim 1, wherein said high-speed photographing button is made of a light permeable material, providing a light emitting portion within an inside thereof.

4. The imaging apparatus, as described in the claim 2, wherein said high-speed photographing button is made of a light permeable material, providing a light emitting portion within an inside thereof.

5. The imaging apparatus, as described in the claim 1, wherein said imaging apparatus is a video camera.

6. The imaging apparatus, as described in the claim 2, wherein said imaging apparatus is a video camera.

7. The imaging apparatus, as described in the claim 3, wherein said imaging apparatus is a video camera.

8. The imaging apparatus, as described in the claim 4, wherein said imaging apparatus is a video camera.
